(19) United States
(12) Patent Application Publication
(10) Pub. No.: US 2007/0044747 A1
(43) Pub. Date: Mar. 1, 2007

(54) Air intake sound control structure

(75) Inventors: Tomoyuki Sawatari, Aichi-ken (JP); Yoshikazu Hirose, Aichi-ken (JP); Shintaro Okawa, Aichi-ken (JP); Tomokazu Inoue, Aichi-ken (JP); Akihito Yamada, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/508,879

(22) Filed: Aug. 24, 2006

(30) Foreign Application Priority Data
Aug. 26, 2005 (JP) 2005-246324
Jun. 16, 2006 (JP) 2006-167688

(51) Int. Cl. F02M 35/10

(52) U.S. Cl. 123/184.21; 123/184.53

(57) ABSTRACT

An air intake sound control structure comprises a sound guiding pipe, a sound producing body, and a silencing means. The sound guiding pipe is branched off from a branch portion formed on a part of an air intake flow passage of an automobile, communicating with the air intake flow passage. The sound producing body is held by the sound guiding pipe at the position spaced apart from the branch portion, thereby sealing the sound guiding pipe, and producing a sound at a frequency which corresponds to its own natural vibration frequency by its vibration. The silencing means is disposed on the side of the branch portion of the sound guiding pipe and canceling a sound at a target frequency for suppression out of the air intake sound. The sound generated by the vibration of the sound producing body is transmitted into a vehicle interior.

### BACKGROUND OF THE INVENTION

1. Field of the Invention

The present invention relates to an air intake sound control structure provided in an air intake flow passage which supplies air to an engine. More particularly, it relates to an air intake sound control structure which reduces an air intake noise, and at the same time can emit a preferred sound in a vehicle interior and exterior.

2. Description of the Related Art

In an air intake system of an automobile engine, there arises a problem in that a noise is generated from an intake port when taking air in. This air intake noise is irritating to ears particularly when the engine runs at low revolution speeds. Hence, a side branch, a resonator, etc. have been disposed in an air intake pipe conventionally, and sounds at specific frequencies, which are calculated based on the Helmholtz resonance theory, have been reduced.

Moreover, attenuating an air intake sound by producing sounds with a reverse phase to an air intake sound from a speaker has been proposed as other means for attenuating an air intake noise. The air intake sound is taken mainly as pressure waves caused by pressure pulsations accompanied with opening and closing an air intake valve. Thus, by adding pressure waves of the same frequencies with the reverse phase so as to cancel the pressure waves, both waves interfere with each other and are canceled, and amplitudes of air intake sound waves, namely, a sound pressure can be attenuated.

For example, Japanese Unexamined Utility Model Publication (KOKAI) No. 63-113,759, proposes a means for attenuating an air intake sound. In such a means, a microphone and a speaker unit are installed in the midway of an intake pipe. A sound pressure signal sensed by the microphone and a phase signal from a crank angle sensor are input into a control unit, and an amplitude and a phase of the sound with a reverse phase to the air intake sound are obtained by a calculation. The information is transmitted to the speaker unit, and a sound wave having the amplitude which is almost identical with the air intake sound and with the phase reverse to the air intake sound is generated.

Meanwhile, it is preferable that the air intake sound which accords with a driving condition can be perceived in a vehicle interior. That is, by making the loud air intake sound audible when stepping on an accelerator, and by making the quiet air intake sound audible when an engine is idling and so on, the air intake sound accords with the driving condition and thus a preferable driving feeling can be obtained. With that, the application of the technique disclosed in the above publication can be considered. That is, the sound pressure signal sensed by the microphone and the phase signal from the crank angle sensor are input to the control unit, and the amplification degree of the sound transferred to the vehicle interior is controlled by the calculation.

However, when the speaker is disposed in the midway of the air intake pipe, the sound of the speaker leaks from the intake port so that the vehicle exterior noise increases. Moreover, since the distance from the speaker to the vehicle interior is long, the propagation loss is large, and it can be hardly said that the evaluation in the vehicle interior is preferable.

Hence, Japanese Unexamined Patent Publication (KOKAI) No. 2005-139,982 proposes a sound quality control apparatus comprising a resonator having a resonant body which vibrates by an air intake pulsation in an air intake system, a volume chamber connected to the air intake system by way of the resonant body, and an opening portion of the volume chamber which makes the internal space of the volume chamber communicate with the outside, wherein the resonator is designed such that the resonant body partitions between the internal space of the volume chamber and the inside of the air intake system, and a sound pressure of a predetermined frequency band is emitted from the opening portion of the volume chamber to the outside by the vibration of the resonant body.

In the publication, it is disclosed that since the sound pressure of the sound of the frequency band which depends on a natural vibration frequency of the resonant body, a volume of the volume chamber, and a shape of the opening portion of the volume chamber is added to the air intake sound, the air intake sound in the vehicle interior can, without using a speaker, be controlled while following accelerator opening degrees.

However, in the sound quality control apparatus described above, even though the sound at the specific frequency corresponding to the natural vibration frequency of the resonant body is amplified, it is difficult to suppress unnecessary sounds out of the air intake sound, and particularly difficult to suppress the emission of the sounds of low frequencies which become booming noises.

### SUMMARY OF THE INVENTION

The present invention has been developed and completed in view of such circumstances. It is therefore an object of the present invention to make it possible to reduce an air intake noise, and at the same time to emit a preferred sound to the vehicle interior.

An air intake sound control structure according to the present invention can achieve the aforementioned object, and comprises:

a sound guiding pipe branched off from a branch portion formed on a part of an air intake flow passage of an automobile, communicating with the air intake flow passage, and propagating an air intake sound therethrough;

a sound producing body held by the sound guiding pipe at the position spaced apart from the branch portion, thereby sealing the sound guiding pipe, and producing a sound at a frequency which corresponds to its own natural vibration frequency by vibration; and

a silencing means disposed on the side of the branch portion of the sound guiding pipe and canceling a sound at a target frequency for suppression out of the air intake sound, wherein:

the sound generated by the vibration of the sound producing body is transmitted into a vehicle interior.

The air intake sound control structure set forth in claim 1, wherein an intermediate vibrating plate defining the inside of the sound guiding pipe at the position spaced apart from the sound producing body to the side of the branch portion and is vibratable at the natural vibration frequency same as that of the sound producing body, and a compartment defined by the sound producing body and the intermediate vibrating plate are provided in the inside of the sound guiding pipe.

In the air intake sound control structure according to the present invention, because the sound at the target frequency for suppression in the air intake sound is canceled by the silencing means, the air intake noise from the intake port perceived from the vehicle exterior can be reduced. And, the sound producing body resonates with the sound at the specific frequency in the air intake sound, and accordingly the sound produced by the resonance is emitted from the sound guiding pipe to the outside. Therefore, by disposing the sound producing body adjacent to the vehicle interior, the sound at the specific frequency can be supplied into the vehicle interior, and the air intake sound can be made to be the sound following the accelerator opening degrees. As such, the air intake sound perceived in the vehicle interior can be controlled to be preferable.

And, because the silencing means exists closer to the side of the air intake flow passage than to the sound producing body, the silencing effect by the silencing means is maintained, even when the natural vibration frequency changes due to the deterioration, etc. of the sound producing body. At least, the reduction effect on the air intake noise perceived in the vehicle exterior can be maintained.

Moreover, the air intake sound control structure of the present invention has the intermediate vibrating plate which defines the inside of the sound guiding pipe at the position spaced apart from the sound producing body to the side of the branch portion and can vibrate at the natural vibration frequency same as that of the sound producing body, and the compartment defined by the sound producing body and the intermediate vibrating plate, in the inside of the sound guiding pipe. Thus, the intermediate vibrating plate resonates with the sound at the specific frequency, and the vibration is transmitted to the sound producing body by way of gas in the compartment such that the sound producing body resonates.

Here, since the gas in the compartment has lower stiffness than that of the sound producing body, the sound pressure of the sound at other than the specific frequency decreases while being transferred by the gas. This operational advantage is large for the sounds in the low frequency range, so that the sound pressure of booming noises, etc. of low frequencies particularly decreases. Therefore, the sound pressure of the sound at the specific frequency emitted by the resonance of the sound producing body can be maintained to be high, and simultaneously the sound pressure of the sound at other than the specific frequency can be decreased. Accordingly, the air intake noise can be reduced further, and the air intake sound perceived in the vehicle interior can be controlled to be preferable.

Moreover, since the silencer such as a resonator, etc. can be further formed in the silencing means or the compartment, the sound pressure of the sounds at target frequencies for suppression can be reduced, and the air intake sound perceived in the vehicle interior can be preferable.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms part of the disclosure:

FIG. 1 is a cross sectional view for schematically illustrating an air intake sound control structure according to Example No. 1 of the present invention;

FIG. 2 is a perspective view for illustrating a major part of the air intake sound control structure according to Example No. 1 of the present invention;

FIG. 3 is a graph for illustrating the relationship between an engine revolution speed and sound pressure;

FIG. 4 is a cross sectional view for schematically illustrating an air intake sound control structure according to Example No. 2 of the present invention;

FIG. 5 is a cross sectional view for schematically illustrating an air intake sound control structure according to Example No. 3 of the present invention;

FIG. 6 is a cross sectional view for schematically illustrating an air intake sound control structure according to Example No. 4 of the present invention;

FIG. 7 is a cross sectional view for schematically illustrating an air intake sound control structure according to Example No. 5 of the present invention;

FIG. 8 is a cross sectional view for schematically illustrating an air intake sound control structure according to Example No. 6 of the present invention;

FIG. 9 is a cross sectional view for schematically illustrating an air intake sound control structure according to Example No. 7 of the present invention;

FIG. 10 is a cross sectional view for schematically illustrating an air intake sound control structure according to Example No. 8 of the present invention;

FIG. 11 is a cross sectional view for schematically illustrating an air intake sound control structure according to Example No. 9 of the present invention;

FIG. 12 is a cross sectional view for schematically illustrating an air intake sound control structure according to Example No. 10 of the present invention;

FIG. 13 is a cross sectional view for schematically illustrating an air intake sound control structure according to Comparative Example No. 1;

FIG. 14 is a graph for illustrating the relationship between a frequency and a sound pressure;

FIG. 15 is a cross sectional view for schematically illustrating an air intake sound control structure according to Example No. 11 of the present invention;

FIG. 16 is a cross sectional view for schematically illustrating an air intake sound control structure according to Example No. 12 of the present invention;

FIG. 17 is a perspective view for schematically illustrating the air intake sound control structure according to Example No. 12 of the present invention;

FIG. 18 is a cross sectional view for schematically illustrating a modified version of the air intake sound control structure according to Example No. 12 of the present invention; and

FIG. 19 is a cross sectional view for schematically illustrating an air intake sound control structure according to Example No. 13 of the present invention.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

As for a sound at a specific frequency in the present invention, though it is not decisive because it relies on human senses, generally it is the sound at the frequency in the frequency range of 200 Hz to 800 Hz. In an air intake sound control structure according to the present invention, since mainly the sound at the specific frequency is emitted, the sound at the specific frequency is combined with the air intake sound, and thus the combined sound can be perceived in the vehicle interior.

Moreover, a target frequency for suppression refers to a sound which corresponds to an air intake noise perceived in the vehicle exterior. It can be the sound at other than the specific frequency or it can be the same as the sound at the specific frequency.

The air intake sound control structure of the present invention is configured basically from a sound guiding pipe and a sound producing body. The sound guiding pipe has a tubular shape and is branched off from a branch portion formed in a part of an air intake flow passage, and communicates with the air intake flow passage. The position of the branch portion is not limited in particular, such as a side wall of an air intake duct and a side wall of an air cleaner container. And, the sound producing body is held by the sound guiding pipe so as to seal the sound guiding pipe, and produces a sound which corresponds to its own natural vibration frequency by the vibration.

It is preferable to configure the branch portion to be disposed at a portion where antinodes of a standing wave of the target frequency for suppression are positioned in the air intake flow passage. The antinodes of the standing wave of the target frequency for suppression have a large sound pressure. Thus, according to the present configuration, the sound pressure of the target frequency for suppression can be suppressed more effectively.

A side branch-type or a Helmholtz resonator-type silencer cancels the sound at the target frequency for suppression generated in the air intake flow passage by resonance. Whilst, when a part of wall surfaces of the silencer is configured from the plate-shaped sound producing body which can vibrate with the sound at the specific frequency, it is possible to make the sound producing body resonate by resonance, so that the sound produced by the resonance can be emitted to the outside. Hence, in the present invention, by forming a silencing means and also by providing the sound producing body in the sound guiding pipe, the sound guiding pipe is used as the silencer and also a sound producing apparatus.

For example, when the silencing means is a cylindrical side branch type, the target frequency for suppression depends on the length of the sound guiding pipe. For instance, to cancel the sounds of low frequencies, the sound guiding pipe is made to be long.

Alternatively, when the silencing means is a resonator type, a minor-diameter throat portion and a major-diameter hollow portion at the distal end of the throat portion are formed. In this case, the target frequency for suppression (f) can be expressed by following equation (1):

$$f = \frac{C}{2 π} \sqrt{\frac{S}{I \cdot V}}$$

wherein C specifies sound speed;

l specifies the length of the throat portion;

V specifies the volume of the hollow portion; and

S specifies the cross-sectional area of the throat portion.

In case of canceling the sounds of low frequencies, the target frequency for suppression (f) is low so that l or V needs to be large for S. In this case, by making the throat portion long and by making the depth of the hollow portion shallow, and also by making the diameter major, an increase of an installation space can be suppressed.

A metal plate, a resinous plate, a rubber plate, and so on which produce sounds at specific frequencies corresponding to their own natural vibration frequency by vibration can be selected to be used for the sound producing body. The sound producing body can be formed to have a shape which has the natural vibration frequency corresponding to the intended sound at the specific frequency. The sound producing body is disposed at the position where the sound generated by its own vibration is transmitted into the vehicle interior. For example, the sound producing body can expose in the vehicle interior, or can be disposed to face a panel defining the vehicle interior. Or, the panel itself defining the vehicle interior can be the sound producing body.

It is preferable that, besides the silencing means, one or a plurality of silencers which cancel the sound at other than the specific frequency is provided in the sound guiding pipe. The sound pressure of the sound at the specific frequency produced by the sound producing body relatively increases, and the waveform becomes closer to ideal. Accordingly, the air intake sound transmitted into the vehicle interior can be preferable.

It is also preferable that a plurality of air intake sound control structures having sound guiding pipes of different volumes are formed in the air intake flow passage. In this way, sounds at a plurality of specific frequencies can be emitted simultaneously. In this case, it is preferable that opening-and-closing valves which can control the contact of the air intake sound to the sound producing body on and off are formed in each air intake sound control structure. In this way, it is possible to turn on and off depending on respective specific frequencies. In this way, it is possible to turn respective specific frequencies on and off according to need. For example, only the air intake sound control structure which produces a sound at a necessary specific frequency depending on the revolution speeds of the engine can be turned on. Thus, the air intake sound transmitted into the vehicle interior can be preferable.

Although the opening-and-closing valves can be provided in a boundary of the branch portion, the throat portion, and the hollow portion, and the like so as to control the entry of the air intake sound into the sound guiding pipe on and off, it is particularly preferable that it is provided adjacent to the sound producing body. In this way, even in the case the sound production by the vibration of the sound producing body is turned off, a reduction effect on the air intake noise perceived from the vehicle exterior can be maintained.

Note that the sound producing body can be positioned on a side surface or on an end surface of the sound guiding pipe. Moreover, an entire wall surface of the sound guiding pipe can be the sound producing body, or a part of the wall surface can be the sound producing body. Also note that, to obtain directivity for the sound production, it is preferable to cover the sound producing body by a container having an opening, or to hold the sound producing body in the inner portion from the end surface opening of the sound guiding pipe, and to make the sound produced from these openings.

It is preferable to have an intermediate vibrating plate which defines the inside of the sound guiding pipe at the position spaced apart from the sound producing body to the side of the branch portion and can vibrate at the natural vibration frequency same as that of the sound producing body, and a compartment defined by the sound producing body and the intermediate vibrating plate, in the inside of the sound guiding pipe. A plurality of the intermediate vibrating plates can be disposed, and in this case, the compartments are also disposed between the intermediate vibrating plates.

As in the case of the sound producing body, a metal plate, a resinous plate, a rubber plate, and so on can be selected to be used for the intermediate vibrating plate. The intermediate vibrating plate can be formed to to have a shape which has a natural vibration frequency corresponding to the intended sound at the specific frequency.

In the compartment, air is enclosed generally. Since air has lower stiffness than that of the sound producing body, the sound pressure of the sound at other than the specific frequency decreases while being transferred by air. This operational advantage is large for the sounds in the low frequency range, so that the sound pressure of booming noises, etc. in low frequencies particularly decreases. Therefore, the sound pressure of the sound at the specific frequency emitted by the resonance of the sound producing body can be maintained to be high, and simultaneously the sound pressure of the sound at other than the specific frequency can be decreased. Accordingly, the air intake noise can be reduced further, and the air intake sound perceived in the vehicle interior can be controlled to be preferable.

It is known that the sound pressure reduction coefficient of the sound at other than the specific frequency is in inverse proportion to bulk modulus of elasticity of the gas in the compartment. That is, less bulk modulus of elasticity the gas has, more effectively the sound pressure of the sound at other than the specific frequency is reduced. Therefore, it is desirable that the gas in the compartment has less bulk modulus of elasticity than air, and it is particularly preferable that sulphur dioxide, etc. is enclosed, for example.

In addition, it is known that the reduction effect on the sound at other than the specific frequency is proportional to the volume of the compartment. Therefore, it is desirable to make the volume of the compartment as large as possible.

In the meanwhile, there may arise a case that a resonant sound corresponding to the axial length of the compartment is generated in the compartment. However, while it is particularly a problem when the resonant sound is in low frequencies, it is not so much a problem as the air intake sound control structure for an automobile when the resonant sound is in higher frequencies than the specific frequency. Therefore, it is preferable that the length of the compartment in the axial direction of the sound guiding pipe is shorter than ½ of the wavelength of the sound at the specific frequency. In this way, the resonant sound generated in the compartment can be a higher sound than the sound at the specific frequency.

Further, it is preferable that one or more silencers which communicate with the compartment are provided. For example, by forming a resonator or a side branch on one wall surface of the compartment, it becomes possible to regulate a sound pressure level and/or a frequency range of an emitted sound from the sound producing body, and a waveform of the emitted sound becomes closer to ideal.

Moreover, a vibrating plate which is provided so as to close a branch opening in the branch portion and resonates with the sound at the specific frequency can be adopted as the silencing means. In this case, since the branch opening is closed by the vibrating plate, the entry of the sound at other than the specific frequency into the sound guiding pipe can be suppressed. And, by the resonance of the vibrating plate, the sound at the specific frequency is guided to the sound guiding pipe.

In this case, a compartment defined by the sound producing body and the vibrating plate is formed in the sound guiding pipe. Therefore, as described above, the sound pressure of the sound at the specific frequency emitted by the resonance of the sound producing body can be maintained to be high, and simultaneously the sound pressure of the sound at other than the specific frequency can be decreased.

### EXAMPLES

Hereinafter, the present invention will be described in detail with reference to examples and comparative examples.

### Example No. 1

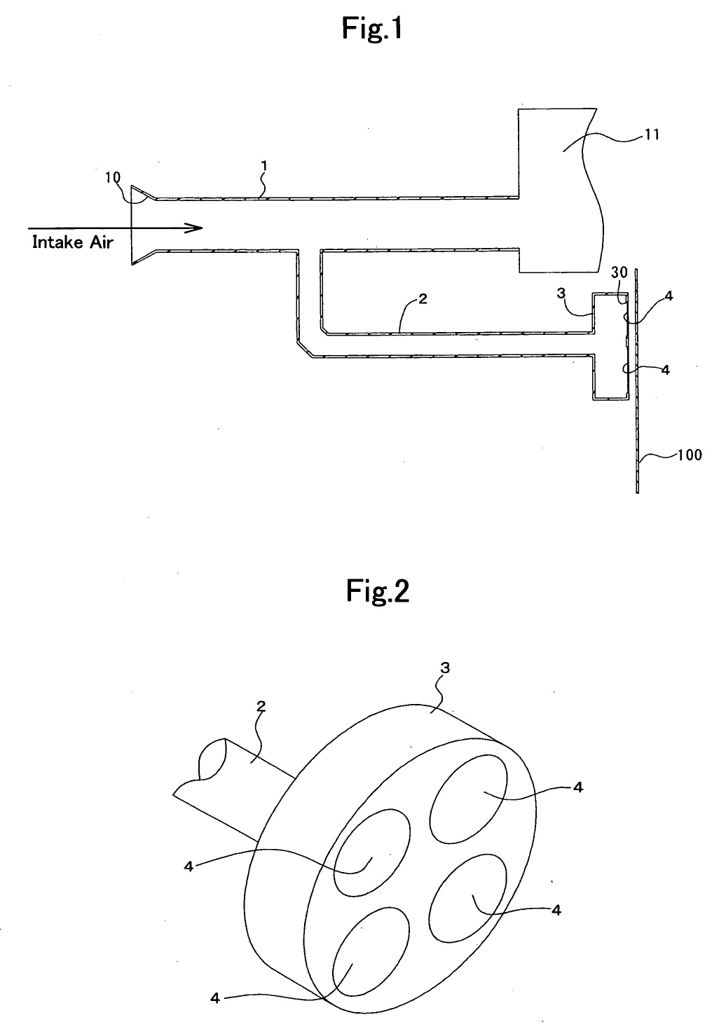

FIGS. 1 and 2 show an air intake sound control structure according to Example No. 1 of the present invention. A branch duct 2 is branched off between an intake port 10 of an air intake duct 1 and an air filter housing 11, and a cylindrical volume chamber 3 is formed at a distal end of branch duct 2. Four through holes 30 are formed in a bottom portion of the volume chamber 3, and the through holes 30 are covered with sound producing bodies 4 which are formed of resinous plates made of PET and have the thickness of 0.5 mm. And, the bottom portion of the volume chamber 3 faces a dash panel 100 defining a vehicle interior and an engine room with a little space therebetween, and a sound generated by the vibration of the sound producing bodies 4 is transmitted into the vehicle interior by way of the dash panel 100.

Here, the branch duct 2 and the volume chamber 3 configure a sound guiding duct of the present invention. Moreover, the branch duct 2 and the volume chamber 3 configure a Helmholtz resonator-type silencer. And, from the length of the branch duct 2 (l), the cross-sectional area of the branch duct 2 (S), and the volume of the volume chamber 3 (V), the sound at a target frequency for suppression (f) which is calculated from equation 1 can be canceled. Accordingly, an air intake noise from the intake port 10 perceived from the vehicle exterior can be reduced.

In the air intake sound control structure according to Example No. 1, the sound producing bodies 4 have their own natural vibration frequency which resonates with the sound at the specific frequency same as the target frequency for suppression (f). Thus, the sound producing bodies 4 resonate by the resonant sound in the volume chamber 3, and the sound producing bodies 4 themselves become a sound source so as to produce the sound at the specific frequency.

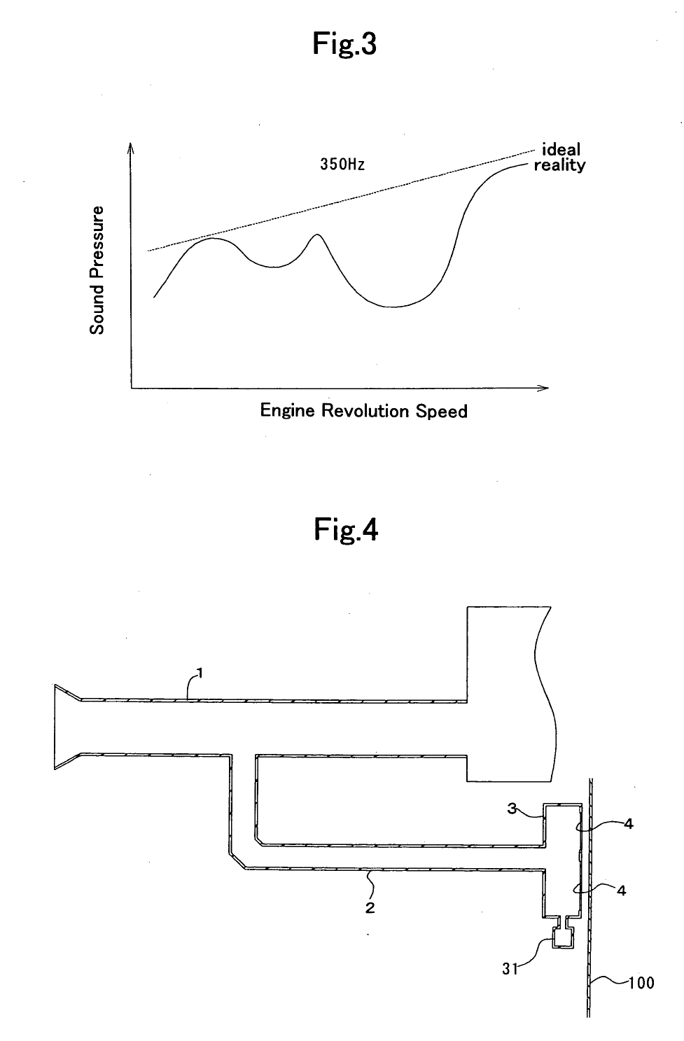

As for the air intake sound perceived in the vehicle interior, as indicated by a broken line in FIG. 3, it is preferable that sound pressure increases linearly as an engine revolution speed increases. However, for example, as indicated by a solid line in FIG. 3 showing the relationship between the sound pressure of the air intake sound of the revolution fourth component perceived in the vehicle interior and the engine revolution speed, there is a problem in that the sound pressure is low in a middle revolution speed range.

Hence, with the air intake sound control structure according to Example No. 1, by appropriately designing the length of the branch duct 2 (l), the cross-sectional area of the branch duct 2 (S), and the volume of the volume chamber 3 (V), the air intake noise at 350 Hz perceived from the vehicle exterior is cancelled, and also the sound producing bodies 4 are designed to vibrate at the specific frequency of 350 Hz. In such a way, it is possible to reduce the vehicle exterior noise, and also possible to add an air intake sound at 350 Hz to the air intake sound perceived in the vehicle interior. Thus, it is perceived as if the sound pressure increases linearly as the engine revolution speed increases.

### Example No. 2

Except that a Helmholtz resonator-type silencer 31 is formed on a wall surface of a volume chamber 3, an air intake sound control structure according to Example No. 2 of the present invention shown in FIG. 4 is identical with Example No. 1.

In the air intake sound control structure according to Example No. 2, a portion of an air intake sound which flows into the volume chamber 3 can be canceled by a cavity resonance of the silencer 31. Therefore, out of the air intake which flows into the volume chamber 3, the sound at a natural frequency based on a shape of the silencer 31, that is, the sound at other than a specific frequency which corresponds to a natural vibration frequency of sound producing bodies 4 can be canceled. Since the waveform of the resonant sound in the volume chamber 3 become closer to ideal, it is possible to make the air intake sound transmitted into the vehicle interior preferable.

### Example No. 3

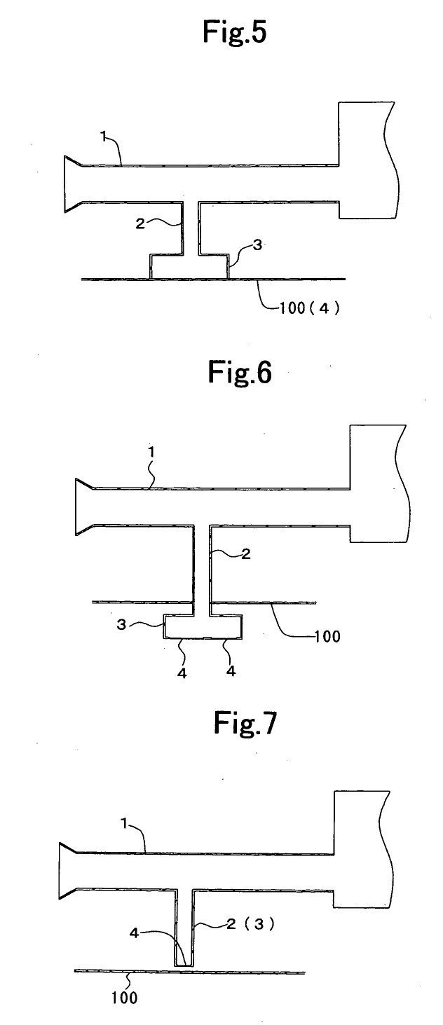

An air intake sound control structure according to Example No. 3 of the present invention is, similarly to Example No. 1, configured from a branch duct 2 and a volume chamber 3. As shown in FIG. 5, a bottom surface of the volume chamber 3 is configured from a dash panel 100. That is, since the dash panel 100 also functions as a sound producing body, and the dash panel 100 vibrates with a resonant sound at its natural frequency (f) which is determined based on a shape of the branch duct 2 and the volume chamber 3, the sound at the specific frequency can be added to an air intake sound perceived in a vehicle interior.

### Example No. 4

An air intake sound control structure according to Example No. 4 of the present invention is, similarly to Example No. 1, formed from a branch duct 2, a volume chamber 3, and sound producing bodies 4. As shown in FIG. 6, the branch duct 2 passes through a dash panel 100, and the volume chamber 3 and the sound producing bodies 4 are exposed into a vehicle interior. In this way, the sound pressure of the sound produced by the sound producing bodies 4 in the vehicle interior increases, thus there may arise a case that an air intake sound can be preferable.

### Example No. 5

An air intake sound control structure according to Example No. 5 of the present invention is, as shown in FIG. 7, configured from a sound guiding duct 2′, and a sound producing body 4 held at a distal end of the sound guiding duct 2′. The sound producing body 4 faces a dash panel 100 defining a vehicle interior and an engine room with a little space therebetween.

In the air intake sound control structure according to Example No. 5, the sound guiding duct 2′ itself configures a side branch-type silencer, and cancel a sound at a target frequency for suppression depending on a length of the sound guiding duct 2′. Thus, an air intake noise from an intake port 10 perceived from a vehicle exterior can be reduced. And, the sound producing body 4 has a natural vibration frequency which resonates with a sound at a specific frequency. Therefore, the sound producing body 4 resonates by the resonant sound of the sound guiding duct 2′, and the sound producing body 4 itself becomes a sound source and produces the sound at the specific frequency.

### Example No. 6

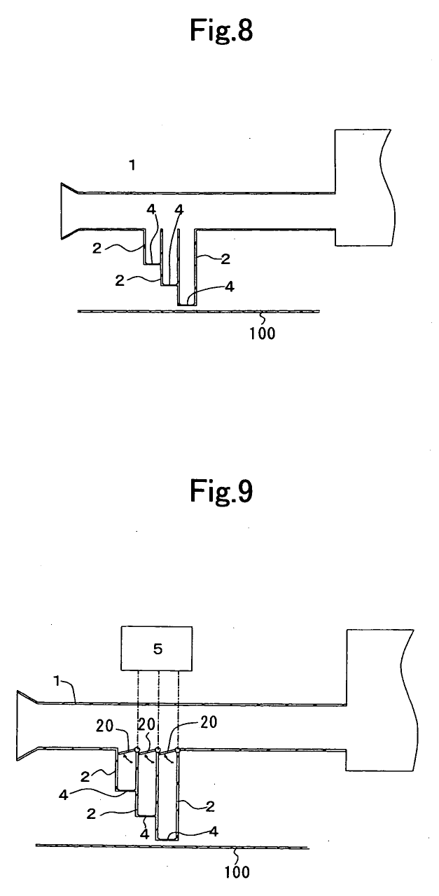

An air intake sound control structure according to Example No. 6 of the present invention is, as shown in FIG. 8, configured from a plurality of sound guiding ducts 2′ and sound producing bodies 4 held at distal ends of each sound guiding duct 2′. The sound producing bodies 4 face a dash panel 100 defining a vehicle interior and an engine room with a little space therebetween.

In the air intake sound control structure according to Example No. 6, each sound guiding duct 2′ itself configures a side branch-type silencer, and can cancel sounds at a plurality of target frequencies for suppression depending on lengths of sound guiding ducts 2′. Therefore, an air intake noise from an intake port 10 perceived from a vehicle exterior can be reduced. And, each sound producing body 4 has its own natural vibration frequency which resonates with sounds at specific frequencies which are cancelled in respective sound guiding duct 2′. Therefore, the sound producing bodies 4 resonate with the resonant sounds of the sound guiding ducts 2′, and the sound producing bodies 4 themselves become sound sources and produce sounds at a plurality of specific frequencies.

### Example No. 7

Except that opening-and-closing valves 20 are disposed at each one of a plurality of branch portions where a plurality of sound guiding ducts 2′ are branched off from an air intake duct 1 such that the entry of air intake to the sound guiding ducts 2′ can be controlled on and off by swinging of the opening-and-closing valves 20, an air intake sound control structure according to Example No. 7 of the present invention shown in FIG. 9 is identical with Example No. 6.

Movements of each opening-and-closing valve 20 are controlled by an actuator, not shown, and the actuation of the actuator is controlled by a control apparatus 5. That is, the control apparatus 5 controls to actuate the actuator on and off based on a predetermined map depending on a value of an engine revolution speed, and controls to open or close sound guiding ducts 2′ by the respective opening-and-closing valves 20.

Therefore, in the air intake sound control structure according to Example No. 7, the sound guiding ducts 2′ into which the air intake enters can be selected depending on a value of the engine revolution speed, and sounds produced by sound producing bodies 4 can be selected from a plurality of sounds with a variety of combinations. Note that opening-and-closing valves 20 can be in the midway of sound guiding ducts 2′.

### Example No. 8

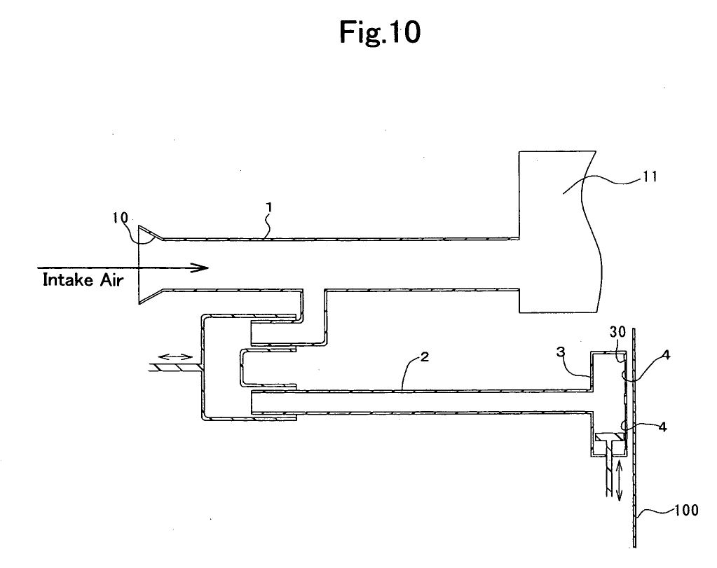

An air intake sound control structure according to Example No. 8 of the present invention is, similarly to Example No. 1, configured from a branch duct 2 and a volume chamber 3. As shown in FIG. 10, the volume of the volume chamber 3 (V), the cross-sectional area of the branch duct 2 (S), and the length of the branch duct 2 (l) are controlled by an actuator, not shown. Accordingly, the target frequency for suppression (f) shown in equation 1 can be varied.

The actuation of the actuator is controlled by a control apparatus, not shown. That is, the control apparatus controls the actuation of the actuator based on a predetermined map depending on a value of an engine revolution speed, and controls the volume of the volume chamber 3 (V), the cross-sectional area of the branch duct 2 (S), and the length of the branch duct 2 (l). Note that one or more among the volume of the volume chamber 3 (V), the cross-sectional area of the branch duct 2 (S), and the length of the branch duct 2 (l) can be variable.

Therefore, the air intake sound control structure according to Example No. 8 produces a sound at a specific frequency depending on a value of the engine revolution speed, and simultaneously can cancel sounds at various frequencies out of an air intake noise perceived in a vehicle exterior.

### Example No. 9

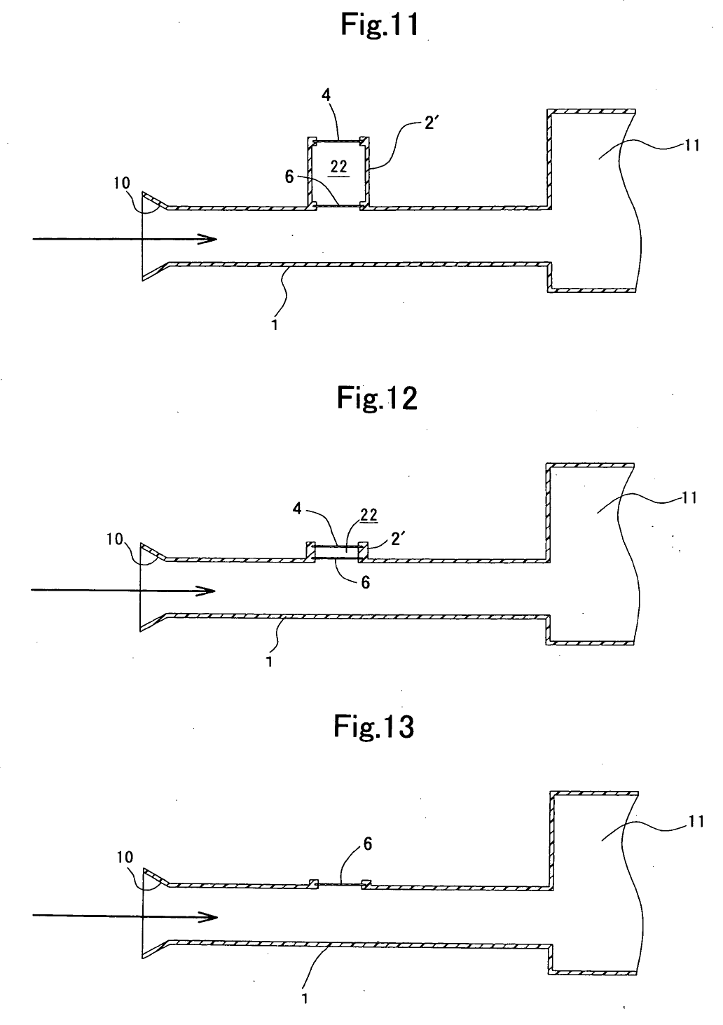

FIG. 11 shows an air intake sound control structure according to Example No. 9 of the present invention. A sound guiding duct 2′ shaped as a cylinder having an inside diameter of 70 mm is branched off between an intake port 10 of an air intake duct 1 made of PP resin and air filter housing 11. The sound guiding duct 2′ is made of PP resin, and a vibrating plate 6 covering an opening of the sound guiding duct 2′ at a connecting portion with the air intake duct 1 and a sound producing body 4 covering a distal end opening of the sound guiding duct 2′ are held in an air-proof manner.

The sound producing body 4 and the vibrating plate 6 are made of PET, formed of resinous plates having thickness of 0.5 mm, and designed to resonate with a sound wave of 340 Hz respectively. The sound producing body 4 and the vibrating plate 6 are installed with an 80-mm space therebetween, and a compartment 22 is formed between the sound producing body 4 and the vibrating plate 6. A volume of the compartment 22 is about 300 cm³, and air at atmospheric pressure is enclosed inside.

### Example No. 10

As shown in FIG. 12, except that a space between a sound producing body 4 and a vibrating plate 6 is 5 mm, and a length of a sound guiding duct 2′ is accordingly made shorter, an air intake sound control structure according to Example No. 10 of the present invention is identical with Example No. 9. A volume of a compartment 22 is about 20 cm³.

### Comparative Example No. 1

As shown in FIG. 13, without forming a sound guiding duct 2′, a vibrating plate 6 which is the same as that of Example No. 9 is held in an opening 12 formed in a duct wall of an air intake duct 1.

### Comparative Example No. 2

Only an air intake duct 1 without a sound guiding duct 2′ and an opening 12 is adapted to an air intake sound control structure according to Comparative Example No. 2.

### Test and Assessment

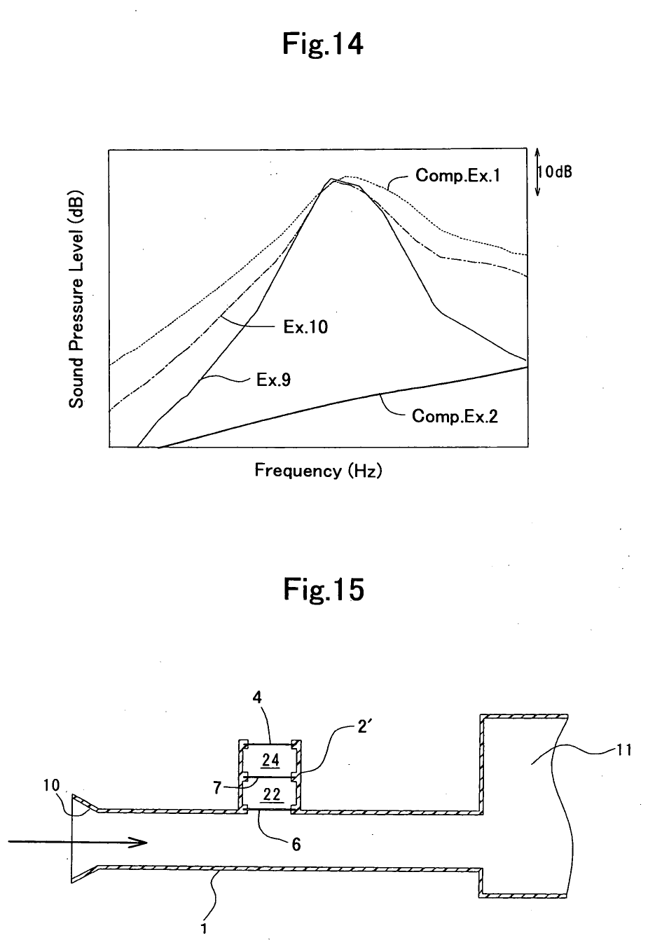

The air intake sound control structures according to Examples Nos. 9, 10 and Comparative Examples Nos. 1, 2 are mounted in automobiles respectively, and sound pressure levels adjacent to sound producing bodies 4 are measured for each frequency. The results are illustrated in FIG. 14.

According to FIG. 14, in Comparative Example No. 1, the sound pressure of the sound at about 330 Hz is higher than that of Comparative Example No. 2. That is, it can be understood that the sound at about 330 Hz is newly added by disposing the vibrating plate 6 in the opening 12, and that the sound at a specific frequency has been generated by a resonance of the vibrating plate 6.

However, in air intake sound control structures according to Examples Nos. 9 and 10, the sound at the specific frequency is added, similarly to Comparative Example No. 1; while the sound pressures of sounds in a low frequency range and in a high frequency range are lower than that of the sound at the specific frequency when compared to Comparative Example No. 1. It is apparent that these are effected by the forming of the sound producing body 4 and the compartment 22.

Further, the comparison between Example No. 9 and Example No. 10 shows that the sound pressures of the sound at the specific frequency are equivalent. On the other hand, the sound pressures of sounds in a low frequency range and in a high frequency range lower to a larger extent in the air intake sound control structure according to Example No. 9. It is understood that this is effected by the enlarging the volume of the compartment 22, and that it is preferable that the compartment 22 has a volume as large as possible.

### Example No. 11

As shown in FIG. 15, except that an intermediate vibrating plate 7 is further disposed between a vibrating plate 6 and a sound producing body 4, an air intake sound control structure according to Example No. 11 of the present invention is identical with Example No. 9. A second compartment 24 is formed between the sound producing body 4 and the intermediate vibrating plate 7. The intermediate vibrating plate 7 is similar to the sound producing body 4 and the vibrating plate 6.

In the air intake sound control structure according to Example No. 11, the intermediate vibrating plate 7 exists in the midway which pressure is transferred from the vibrating plate 6 to the sound producing body 4. Thus, because a part of the pressure is received by the intermediate vibrating plate 7, the pressure transferred to the sound producing body 4 decreases, and sound pressure of sounds at other than a specific frequency can be reduced further than Example No. 9. Moreover, by enlarging a total volume of the compartment, the sound pressure of sounds at other than the specific frequency can be reduced further. Also, the similar effect can be obtained by increasing the number of the intermediate vibrating plate 7.

### Example No. 12

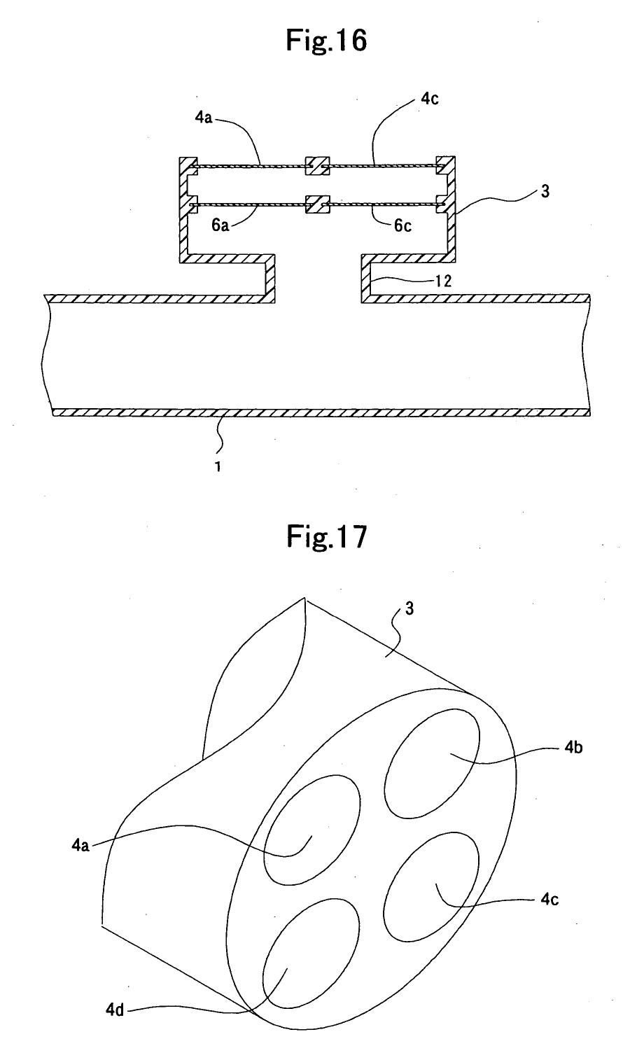

FIGS. 16 and 17 show an air intake sound control structure according to Example No. 12 of the present invention. A branch pipe 12 is branched off from the midway of an air intake duct 1, and a volume chamber 3 whose diameter is larger than that of the branch pipe 12 communicates with a distal end of the branch pipe 12. A length of the volume chamber 3 is the same as that of the sound guiding duct 2′ of Example No. 9, however, a volume of the volume chamber 3 is two times larger than that of the sound guiding duct 2′ of Example No. 9. Four pieces of vibrating members 6a to 6d are held in the intermediate portion in the axial direction of the volume chamber 3. Moreover, four pieces of sound producing bodies 4a to 4d are held at a distal end opening of the volume chamber 3 so as to face four pieces of the vibrating members 6a to 6d in series. The vibrating members 6a to 6d and the sound producing bodies 4a to 4d are similar to the vibrating plate 6 and the sound producing body 4 in Example No. 9, respectively.

In the air intake sound control structure according to Example No. 12, since the vibrating members 6a to 6d and the sound producing bodies 4a to 20d are formed as a pair respectively, forming four pairs in total; sound pressure of a sound at a specific frequency perceived in a vehicle interior can be increased further.

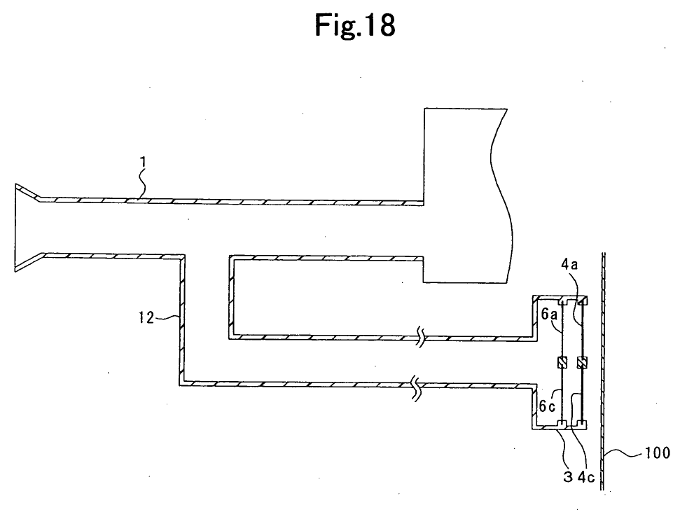

Note that although all four pieces of the vibrating members 6a to 6d or the sound producing bodies 4a to 4d have the same resonant frequency in Example No. 12, each piece can have different resonant frequencies. Moreover, the resonant frequencies can be differentiated between the vibrating members 6a to 6d and the sound producing bodies 4a to 4d. Further, as shown FIG. 18, the branch pipe 12 can be extended so that the volume chamber 3 is disposed at a position where emitted sounds can be easily transmitted into the vehicle interior.

### Example No. 13

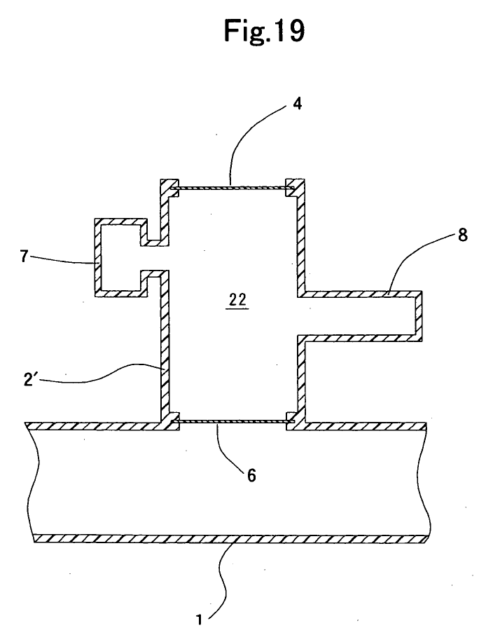

Except that a resonator 7 communicating with a compartment 22 and a side branch 8 communicating with the compartment 22 are provided, an air intake sound control structure according to Example No. 13 of the present invention shown in FIG. 19 is identical with Example No. 9.

In the air intake sound control structure according to Example No. 13, by optimizing the design of the shapes of the resonator 7 and the side branch 8, it becomes possible to regulate a sound pressure level and/or a frequency range of an emitted sound from a distal end of a sound guiding duct 2′, and a waveform of the emitted sound becomes closer to ideal.

Having now fully described the present invention, it will be apparent to one of ordinary skill in the art that many changes and modifications can be made thereto without departing from the spirit or scope of the present invention as set forth herein including the appended claims.

What is claimed is:

1. An air intake sound control structure, comprising:
a sound guiding pipe branched off from a branch portion formed on a part of an air intake flow passage of an automobile, communicating with said air intake flow passage, and propagating an air intake sound therethrough;
a sound producing body held by said sound guiding pipe at the position spaced apart from said branch portion, thereby sealing said sound guiding pipe, and producing a sound at a frequency which corresponds to its own natural vibration frequency by vibration; and
a silencing means disposed on the side of said branch portion of said sound guiding pipe and canceling a sound at a target frequency for suppression out of the air intake sound, wherein:
the sound generated by the vibration of said sound producing body is transmitted into a vehicle interior.

2. The air intake sound control structure set forth in claim 1, wherein said sound producing body is disposed so as to face a panel defining a space of the vehicle interior and an engine room, and the sound generated by the vibration of said sound producing body is transmitted into the vehicle interior.

3. The air intake sound control structure set forth in claim 1, wherein said sound producing body is disposed so as to face a dash panel, and the sound is transmitted into the vehicle interior by way of the dash panel.

4. The air intake sound control structure set forth in claim 1, wherein said sound producing body is held at a distal end of said sound producing pipe, and said silencing means is a side branch-type resonator configured between said sound producing body and said branch portion.

5. The air intake sound control structure set forth in claim 4, wherein a silencer communicating with said sound guiding pipe is provided on an outer wall of said sound guiding duct.

6. The air intake sound control structure set forth in claim 1, wherein said silencing means is a Helmholtz resonator-type resonator consisting of a minor-diameter throat portion and a major-diameter hollow portion, and said sound producing body is held at a distal end of said hollow portion.

7. The air intake sound control structure set forth in claim 6, wherein a silencer communicating with said hollow portion is provided on an outer wall of said hollow portion.

8. The air intake sound control structure set forth in claim 4 or 6, wherein said silencing means has a variable volume means for increasing and decreasing a volume of said silencing means.

9. The air intake sound control structure set forth in claim 1, wherein an intermediate vibrating plate defining the inside of said sound guiding pipe at the position spaced apart from the sound producing body to the side of said branch portion and is vibratable at the natural vibration frequency same as that of said sound producing body, and a compartment defined by said sound producing body and said intermediate vibrating plate are provided in the inside of said sound guiding pipe.

10. The air intake sound control structure set forth in claim 9, wherein a silencer communicating with said compartment is provided on an outer wall of said compartment.

11. The air intake sound control structure set forth in claim 9, wherein a length of said compartment in the axial direction of said sound guiding pipe is shorter than ½ of the wavelength of the sound corresponding to a resonant frequency of said sound producing body.

12. The air intake sound control structure set forth in claim 9, wherein gas in said compartment has less bulk modulus of elasticity than air.

13. The air intake sound control structure set forth in claim 1, wherein said silencing means is a vibrating plate provided at a branch opening of said branch portion and vibrating with a sound at a specific frequency, and has a compartment defined by said sound producing body and said vibrating plate.

14. The air intake sound control structure set forth in claim 9, wherein said silencing means is a side branch-type resonator.

15. The air intake sound control structure set forth in claim 9, wherein said silencing means is a Helmholtz resonator-type resonator.
